(19) United States
(12) Patent Application Publication
(10) Pub. No.: US 2009/0024760 A1
(43) Pub. Date: Jan. 22, 2009

(54) METHOD AND SYSTEM FOR MANAGING COMMUNICATION-SESSIONS IN A NETWORK

(75) Inventors: Subir Saha, Karnataka (IN); Ranjit Avasarala, Karnataka (IN); Samir Dilipkumar Saklikar, Karnataka (IN); Ananth Seetharam, Karnataka (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/161,970

(22) PCT Filed: Feb. 22, 2007
(86) PCT No.: PCT/US07/62542

§ 371 Date: Jul. 24, 2008

(30) Foreign Application Priority Data
Mar. 14, 2006 (IN) 698/DEL/2006

(51) Int. Cl. G06F 15/16

(52) U.S. Cl. 709/242

(57) ABSTRACT

A method for managing communication-sessions at a Communication Diversion Notification Server (CDNS) (108) in a network (100) is disclosed. The method includes receiving (404) a message. The method further includes sending (406) a communication-diversion-notification to the diverting user equipment (UE) (104) based on filter-criteria. The communication-diversion-notification is sent in response to the message. The communication-diversion-notification notifies the diverting UE about the diversion of the communication-session to a target UE (108).

### FIELD OF THE INVENTION

This invention relates generally to the field of networks, and more specifically to a method and a system for managing communication sessions in a network.

### BACKGROUND OF THE INVENTION

The enhanced popularity of networking and communication has resulted in an increase in the number of communication services. An example of such a communication service is a communication-diversion service. This communication-diversion service enables a diverting user equipment (UE), such as a mobile phone, a laptop, a Personal Digital Assistant (PDA), and a Voice over Internet Protocol (VoIP)-enabled phone, to divert a communication session addressed to the diverting UE to another destination, such as a target UE or a voice recorder.

The user of the diverting UE can configure the communication-diversion service. For example, the user of the diverting UE can define a diversion policy to divert all incoming calls between 10:00 P.M. to 07:00 A.M. to a voice mail everyday. The communication-diversion service can also be configured to handle complex situations. For example, an incoming call can be diverted to a voice recorder if the incoming call is from a@abc.com or the status of the user of the diverting UE is set to ‘in meeting’. Due to the increase in the number of configurations, as well in the complexity of configurations, the user of the diverting UE can lose track of the configurations for different situations.

In an existing technique, the user of the diverting UE can receive a communication diversion indication to indicate the diversion of a communication-session. This technique lacks flexibility since the user of the diverting UE can only control whether the communication diversion indication should be received. The user cannot however customize the communication diversion indication. For example, a user cannot customize the communication diversion indication to receive desired information only, such as the time of diversion and address of the caller UE. Further, the user cannot control the rate at which the communication diversion indications are received. In addition, the communication diversion indications may not be in a standard format, and therefore cannot be uniformly implemented across UEs from different vendors.

### BRIEF DESCRIPTION OF THE FIGURES

The present invention is illustrated by way of example, and not limitation, in the accompanying figures, where like reference numerals refer to identical or functionally similar elements throughout the separate views and which together with the detailed description below arc incorporated, and in which:

FIG. 1 is a block diagram illustrating an exemplary network where various embodiments of the present invention can be practiced;

FIG. 2 is a block diagram illustrating a Communication Diversion Notification Server (CDNS), in accordance with an embodiment of the present invention;

FIG. 3 is a block diagram illustrating a diverting user equipment (UE), in accordance with an embodiment of the present invention;

FIG. 4 is a flow diagram illustrating a method for managing communication-sessions at the CDNS in a network, in accordance with an embodiment of the present invention;

FIG. 5 is a call flow diagram illustrating a method for managing communication-sessions in a network, in accordance with an embodiment of the present invention; and

FIG. 6 is a call flow diagram illustrating the method of managing the communication-sessions in an Internet protocol Multimedia Subsystem (IMS) network, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE VARIOUS EMBODIMENTS

An embodiment of the present invention describes a method of managing communication-sessions at a Communication Diversion Notification Server (CDNS) in a network. The method includes receiving a message. The message may be a session initiation message or another message providing information about the diversion of a communication session. The method farther includes sending a communication-diversion-notification to the diverting user equipment (UE) based on filter-criteria. The communication-diversion-notification is sent in response to the message. The communication-diversion-notification notifies the diverting UE about the diversion of the communication-session to the target UE.

Another embodiment of the present invention describes a Communication Diversion Notification Server (CDNS). The CDNS includes a memory, a processor and a transceiver. The memory stores filter-criteria, based on the which, the processor generates a communication-diversion-notification. Thereafter, the transceiver sends the communication-diversion-notification to the diverting UE. The communication-diversion-notification notifies a diverting UE about the diversion of a communication-session to a target UE.

Yet another embodiment of the present invention describes a diverting UE. The diverting UE includes a processor and a transceiver. The processor configures filter-criteria for a communication-diversion notification-service. This communication-diversion notification-service provides a communication-diversion-notification to the diverting UE when a communication-session for the diverting UE is diverted to a target UE. The transceiver receives the communication-diversion-notification based on the filter-criteria.

Before describing in detail the particular the method and system for managing communication-sessions in a network in accordance with various embodiments of the present invention, it should be observed that the present invention resides primarily in combinations of method steps and system elements related to the method and system for the managing communication-sessions in the network. Accordingly, the method steps and the system elements have been represented where appropriate by conventional symbols in the figures, showing only those specific details that are pertinent to understanding the present invention so as not to obscure the disclosure with details that will be readily apparent to those of ordinary skill in the art having the benefit of the description herein.

In this document, relational terms such as first and second and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

A term ‘another’, as used herein, is defined as at least a second or more. The terms ‘including’ and/or ‘having’, as used herein, are defined as comprising.

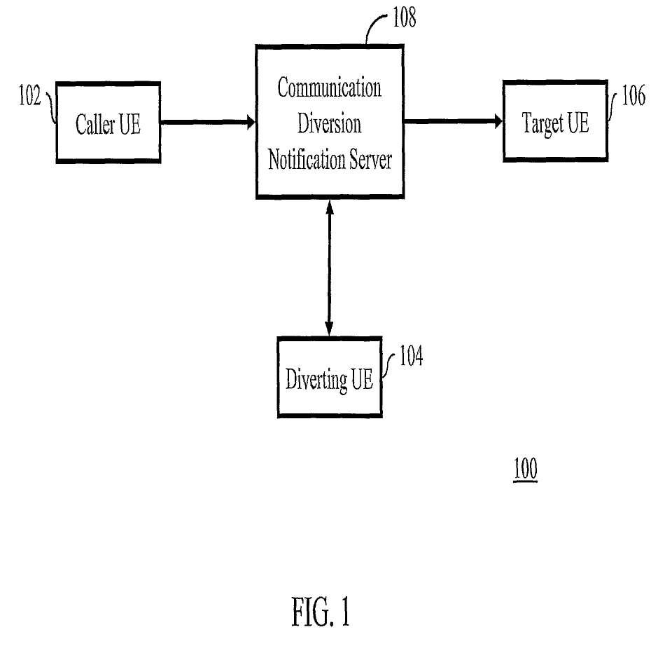

FIG. 1 is a block diagram illustrating an exemplary network 100 where various embodiments of the present invention can be practiced. The network 100 includes a plurality of user equipments (UEs) such as a caller user equipment (UE) 102, a diverting UE 104, a target UE 106, and a Communication Diversion Notification Server (CDNS) 108. The plurality of UEs communicates among themselves by establishing communication-sessions. Typically, a communication-session is established through the CDNS 108.

The user of the diverting UE 104 can configure communication-diversion services, for example Communication Diversion (CDIV) services. These communication diversion services enable the diversion of a communication-session, addressed to the diverting UE 104 to another destination such as to the target UE 106. The communication-diversion services also enable the user to configure a specific service, such as a Communication Forwarding Unconditional (CFU.) service, a Communication Forwarding Busy (CFB) service, a Communication Forwarding on No Logged-In (CFNL) service, a Communication Deflection (CD) service, and a Communication Forwarding No Reply (CFNR) service. Communication diversion services such as CDIV services also enable the user to define a diversion policy to customize the communication diversion. For example, the user of the diverting UE 104 can define a diversion policy to divert all incoming calls between 10:00 P.M. to 07:00 A.M. to a voice recorder. Typically, the diversion policy is based on factors such as the identity of the caller UE 102. In an embodiment of the present invention, the CDNS 108 diverts the communication-session addressed to the diverting UE 104 to the target UE 106, based on the diversion-policy of the diverting LTE 104. In an embodiment of the present invention, the CDNS 108, after the diversion of the communication-session to the target UE 106, sends a communication diversion-notification to the diverting UE 104. In another embodiment of the present invention, the CDNS 108, prior to the diversion of the communication-session to the target UE 106, sends a communication diversion-notification to the diverting UE 104. In yet another embodiment of the present invention, the CDNS 108, while diverting the communication-session to the target UE 106, sends a communication diversion-notification to the diverting UE 104. The communication-diversion-notification notifies the diverting UE 104 about the diversion of the communication-session to the target UE 106.

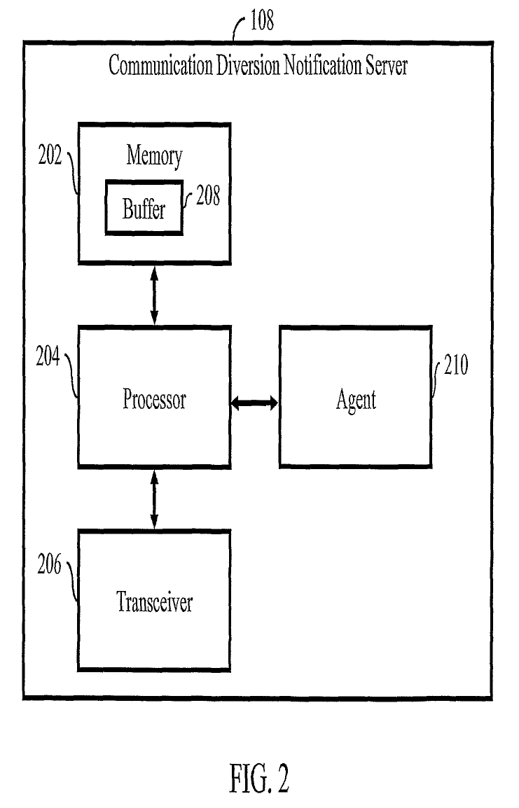

FIG. 2 is a block diagram illustrating the CDNS 108, in accordance with an embodiment of the present invention. The CDNS 108 includes a memory 202, a processor 204, and a transceiver 206. The memory 202 stores filter-criteria, based on which the processor 204 generates a communication-diversion-notification to notify the diverting UE 104 about the diversion of a communication-session to the target UE 106. In an embodiment of the present invention, the filter-criteria can be defined by the user of the diverting UE 104. For example, the filter-criteria can be defined such that the communication-diversion-notification is sent to the diverting UE 104 only when a communication-session originating from the caller UE 102 is diverted. Typically, the filter-criteria are defined during subscribing to the communication-diversion notification-service. In another embodiment of the present invention, the filter-criteria determine the content of the communication-diversion-notification. The content of the communication-diversion-notification can include information associated with the caller UE 102, the information associated with the diverting UE 104, the information associated with the target UE 106, the time of the diversion of a communication-session, reasons for the diversion of a communication-session, and a rule for diverting a communication-session. For example, a communication-diversion-notification can include the identification of the caller UE 102, the identification of the target UE 106, the time at which a communication-session was diverted and the rule that caused the diversion. In an embodiment of the present invention, the rule includes an identifier of a communication diversion rule causing the diversion of the communication-session.

After the communication-diversion-notification is generated, the transceiver 206 of the CDNS 108 sends the communication-diversion-notification to the diverting UE 104. In an embodiment of the present invention, the communication-diversion-notification is sent to the diverting LTE 104 at a pre-defined rate. For example, communication-diversion-notifications can be sent hourly, daily, in real time, or in a defined time interval. The pre-defined rate can be configured by the user of the diverting UE 104. In an embodiment of the present invention, the format of the communication-diversion-notification is based on an Extensible Mark up Language (XML)-based schema.

In an embodiment of the present invention, the memory 202 includes a buffer 208, which stores a communication-diversion-notification when the diverting UE 104 is powered-off. Thereafter, the communication-diversion-notification is sent to the diverting UE 104 when the diverting UE 104 is powered-on. In another embodiment of the present invention, the buffer 208 stores a communication-diversion-notification when the diverting UE 104 is out of the coverage area of the network 100. Thereafter, the communication-diversion-notification is sent to the diverting UE 104 when the diverting UE 104 comes within coverage area of the network 100.

In an embodiment of the present invention, the CDNS 108 includes an agent 210 which processes one or more communication-diversion-notifications. Based on the processing of the one or more communication-diversion-notifications, the agent 210 generates a report which can be in the form of a graph, a message, a voice mail, and so forth. Thereafter, the report is sent to the diverting UE 104. The report can enable the user of the diverting UE 104 to detect a mismatch between the diversion of the communication-session and an expected diversion of the communication-session. For example, the user of the diverting UE 104 can, by mistake, configure a diversion-policy to divert all incoming calls to a voice mail for 15 hours instead of 1.5 hours. The agent 210 might compare it with a previous pattern of diversions and generates a report. For example, the report may be a text message containing “All calls have been diverted to your voice mail for the last three hours”. On receiving the report, the user of the diverting UE 104 can detect the mismatch between the diversion of the communication-session, that is 15 hours, and the expected diversion of the communication-session, that is 1.5 hours. The report can be notified to the user of the diverting UE 104 by a beep, a vibration of the diverting UE 104, a flicker, a text message, an icon displayed on the screen of the diverting UE 104, and so forth.

In another embodiment of the present invention, the agent 210 can create an expected communication-diversion policy for the diverting UE 104. This expected communication-diversion policy can be based on the previous communication-diversion-notifications, the previous communication-diversion policies of the user of the diverting UE 104, and so forth.

In an embodiment of the present invention, the communication-diversion-notification is provided by a communication-diversion notification-service when the user of the diverting UE 104 has subscribed to it. In an embodiment of the present invention, the communication-diversion notification-service uses a Session Initiation Protocol (SIP)-based Event Notification Framework.

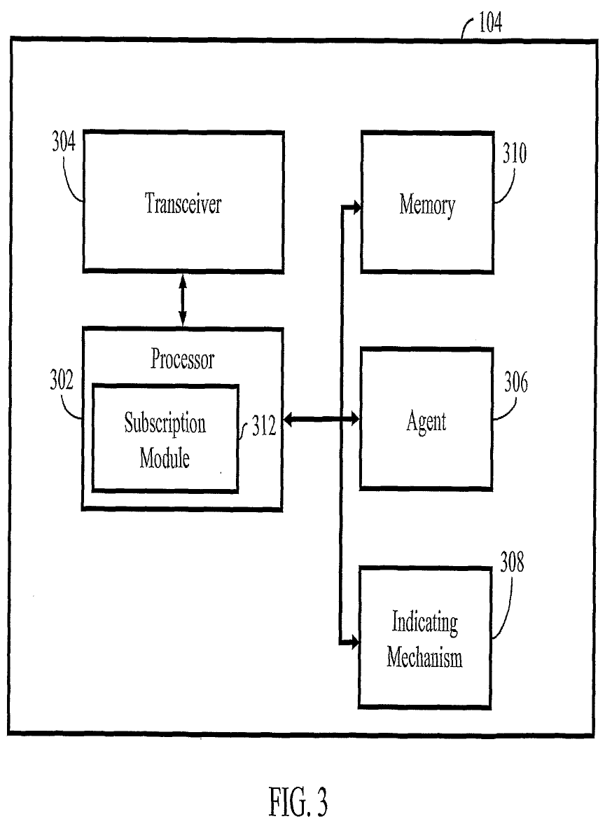

FIG. 3 is a block diagram illustrating the diverting UE 104, in accordance with an embodiment of the present invention. The diverting UE 104 includes a processor 302 and a transceiver 304. The processor 302 can configure filter-criteria for the communication-diversion notification-service. These filter-criteria determine the content of the communication-diversion-notification. The content of the communication-diversion-notification can include the information associated with the caller UE 102, the information associated with the diverting UE 104, the information associated with the target UE 106, the time of the diversion of a communication-session, the reasons for the diversion of a communication-session, and the rule for diverting a communication-session. In an embodiment of the present invention, a user of the diverting UE 104 can configure the filter-criteria. In an embodiment of the present invention, the processor 302 can also configure the pre-defined rate for receiving the communication-diversion-notification. For example, communication-diversion-notifications can be sent hourly, daily, in real time, or in a defined time interval. The pre-defined rate can also be configured by the user of the diverting UE 104.

In an embodiment of the present invention, the diverting UE 104 includes an agent 306 which processes one or more communication-diversion-notifications. Based on the processing of the one or more communication-diversion-notifications, the agent 306 generates a report to enable the user of the diverting UE 104 to detect a mismatch between the diversion of the communication-session and an expected diversion of the communication-session.

The diverting UE 104 may further include an indication mechanism 308, which provides an indication pertaining to the communication-diversion-notification to the user of the diverting UE 104. This indication can be in the form of a beep, a vibration, a flashing icon, a text message, a graph, a voice message, and by the generation of a diverted-call log. Further, the diverting UE 104 may include a memory 310 for storing the one or more communication-diversion notifications. In an embodiment of the present invention, the processor 302 includes a subscription module 312, which subscribes to the communication-diversion notification-service. The subscription to the communication-diversion notification-service enables the diverting UE 104 to receive the communication-diversion-notifications.

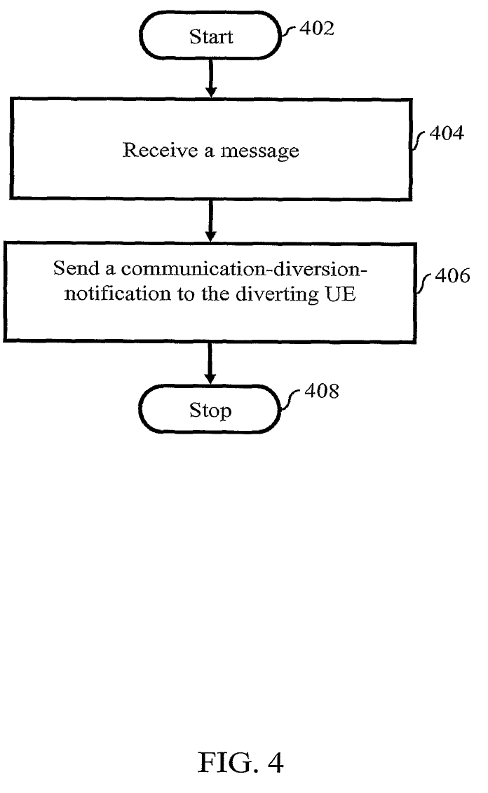

FIG. 4 is a flow diagram illustrating a method for managing communication-sessions at the CDNS 108 in the network 100, in accordance with an embodiment of the present invention. At step 402, the method is initiated. At step 404, a message is received. In an embodiment of the present invention, the message is a session initiation message to establish the communication-session between the caller UE 102 and the diverting UE 104. In another embodiment of the present invention, the message provides information regarding diversion of the communication session to the CDNS 108. In an embodiment of the present invention, the communication-session is diverted to the target UE 106 based on a diversion-policy of the diverting UE 104. At step 406, a communication-diversion-notification is sent to the diverting UE 104 based on filter-criteria. The communication-diversion-notification is sent in response to the message. In an embodiment of the present invention, the user of the diverting UE 104 configures the filter-criteria. Typically, the filter-criteria determine the content of the communication-diversion-notification. The content of the communication-diversion-notification can include the information associated with the caller UE 102, the information associated with the diverting UE 104, the information associated with the target UE 106, the time of the diversion of a communication-session, the reasons for the diversion of a communication-session, and the rule for diverting a communication-session. In an embodiment of the present invention, the communication-diversion-notification is sent at a pre-defined rate. Typically, the communication-diversion-notification is sent to the diverting UE 104, when the diverting UE 104 has subscribed for the communication-diversion notification-service.

In an embodiment of the present invention, various tags are incorporated in policy description language to include details about the diversion of the communication-session in a communication-diversion notification. Typically, the user of the diverting UE 104 sets the tags during uploading the policy description language. In an embodiment of the present invention, the communication-diversion-notification is based on XML-based schema. In an embodiment of the present invention, the communication-diversion-notification is provided by a communication-diversion notification-service. Typically, the communication-diversion notification-service service is based on a Session Initiation Protocol (SIP)-based Event Notification Framework. After sending the communication-diversion-notification the method terminates at step 408.

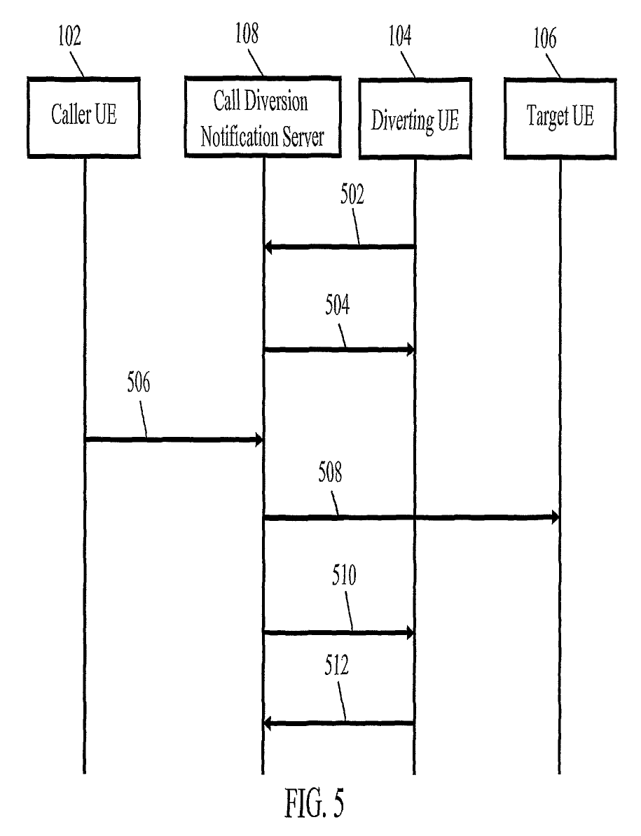

FIG. 5 is a call-flow diagram illustrating a method for managing communication-sessions in the network 100 in accordance with an embodiment of the present invention. To describe the call-flow diagram, reference will be made to FIG. 1, although it is understood that the call flow can be implemented with reference to any other suitable embodiment of the invention. In addition, the call-flow diagram 500 can contain a larger or fewer numbers of steps than shown in FIG. 5. In an embodiment of the present invention, the diverting UE 104 defines a diversion-policy to divert the communication-sessions originating from the caller UE 102 to the target UE 106. In an embodiment of the present invention, the diverting UE 104 sends a subscribe message 502 to the CDNS 108. The subscribe message 502 registers the diverting UE 104 for the communication-diversion notification-service. Typically, the communication-diversion notification-service is based on a Session Initiation Protocol (SIP)-based Event Notification Framework. In an embodiment of the present invention, the subscribe message 502 includes the filter-criteria defined by the user of the diverting UE 104. The subscribe message 502 also specifies the pre-defined rate for sending the communication-diversion-notification.

After receiving the subscribe message 502, the CDNS 108 registers the diverting UE 104 for the communication-diversion notification-service. After successful registration of the diverting UE 104, the CDNS 108 sends an acknowledgment 504 to the diverting UE 104, indicating the successful registration of the diverting UE 104. The caller UE 102 sends a message 506 to the CDNS 108. In an embodiment of the present invention, the message 506 is a session initiation message to establish a communication-session between the caller UE 102 and the diverting UE 104. Typically, after receiving the message 506, the CDNS 108 diverts the communication-session to the target UE 106 based on the diversion-policy of the diverting UE 104. In an embodiment of the present invention, the CDNS 108 sends an invite message 508 to the target UE 106 to divert the communication-session to the target UE 106. After diverting the communication-session to the target UE 106, the CDNS 108 sends a communication-diversion-notification 510 to the diverting UE 104. After receiving the communication-diversion-notification 510, the diverting UE 104 sends an acknowledgement 512 to indicate that the communication-diversion-notification 510 has been successfully received.

In an embodiment of the present invention, the format of the communication-diversion-notification can be based on XML-based schema. In another embodiment of the present invention, various tags are incorporated in policy description language to include the details of the diversion of a communication-session in the communication-diversion notification. Typically, the user of the diverting UE 104 sets the tags during uploading the policy description language.

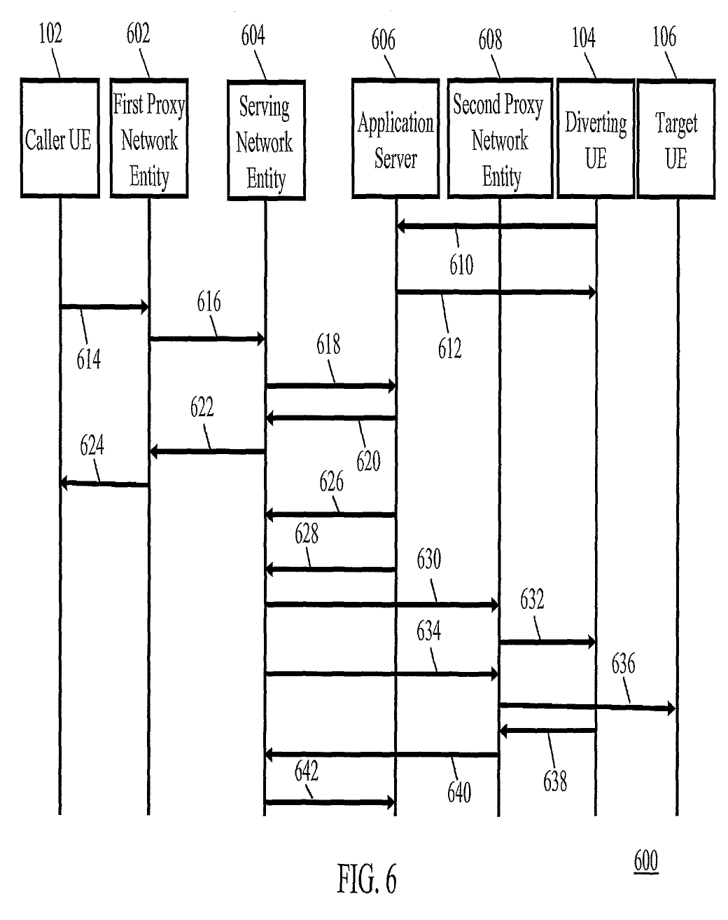

FIG. 6 is a call-flow diagram illustrating the method of managing the communication-sessions in an IMS network 600, in accordance with an embodiment of the present invention. To describe the call-flow diagram, reference will be made to FIG. 1, although it is understood to a person ordinarily skilled in the art that the call flow can be implemented with reference to any other suitable embodiment of the present invention. In addition, the call-flow diagram can contain a greater or fewer numbers of steps than shown in FIG. 6. The IMS network 600 includes the caller UE 102, the diverting UE 104, the target UE 106, a first proxy network entity 602, a serving network entity 604, an Application Server (AS) 606, and a second proxy network entity 608. The first proxy network entity 602 connects the caller UE 102 to the IMS network 600. In an embodiment of the present invention, the first proxy network entity 602 can be a Proxy-Call State Control Function (P-CSCF). The serving network entity 604 provides services, such as registrations, routings and authorizations for the caller UE 102, the diverting UE 104 and the target UE 106. Typically, the serving network entity 604 can be a Serving-Call State Control Function (S-CSCF). The AS 606 executes an application service such as a Call Forward Unconditional (CFU) service for the diverting UE 104, to divert all incoming calls for the diverting UE 104 to the target UE 106. In an embodiment of the present invention, the AS 606 may be the CDNS 108 implementing a communication-diversion notification-service. The AS 606 may also implement an Initial Filter Criteria (IFC) for routing.

In an embodiment of the present invention, the diverting UE 104 sends a subscribe message 610 to the CDNS 108. Typically, the diverting UE 104 subscribes to the communication-diversion notification-service as well as the application service, such as, the CFU service. The subscribe message 610 registers the diverting UE 104 for the communication-diversion notification-service. Typically, the communication-diversion notification-service is based on a Session Initiation Protocol (SIP)-based Event Notification Framework. In an embodiment of the present invention, the subscribe message 610 includes the filter-criteria defined by the user of the diverting UE 104. The subscribe message 610 also specifies the pre-defined rate for sending the communication-diversion-notification.

In an embodiment of the present invention, the format of the communication-diversion-notification can be based on XML-based schema. Typically, various tags are incorporated in policy description language to include the details of the diversion of a communication-session in the communication-diversion notification. In an embodiment of the present invention, the user of the diverting UE 104 sets the tags during uploading the policy description language.

After receiving the subscribe message 610, the AS 606 registers the diverting UE 104 for the communication-diversion notification-service. After successful registration of the diverting UE 104, the AS 606 sends an acknowledgment 612 to the diverting UE 104, indicating the successful registration. The caller UE 102 sends a message 614 to the first proxy network entity 602. In an embodiment the message 614 is the session initiation message to establish a communication-session with the diverting UE 104. The first proxy network entity 602, on receiving the message 614, forwards it to the serving network entity 604 in form of a message 616. The serving network entity 604 forwards the message 614, in form of a message 618 to the AS 606. After executing the appropriate application service such as the CFU service, the AS 606 sends the diversion message 620 to the serving network entity 604, to indicate the diversion of the communication-session to the caller UE 102. The serving network entity 604 forwards the diversion message 620 to the first proxy network(entity 602 in form of a message 622. Further, the first proxy network entity 602 forwards the diversion message 620, to the caller UE 102 in form of a message 624.

The AS 606 sends a message 626 to the serving network entity 604 to establish a communication-session between the caller UE 102 and the target UE 106. The AS 606 executes the communication-session diversion-service which provides the communication-diversion-notification 628, indicating the diversion of the communication-session. The AS 606 sends the communication-diversion-notification 628 for the diverting UE 104 to the serving network entity 604. The serving network entity 604 forwards the communication-diversion-notification 628 to a second proxy network entity 608 in form of a message 630. Thereafter, the second proxy network entity 608 forwards the communication-diversion-notification 628 to the diverting UE 104, in form of a message 632.

After receiving the message 626, the serving network entity 604 forwards it to the second proxy network entity 608, in form of a message 634. The second proxy network entity 608 forwards the message 626 to the target UE 106 in form of a message 636. After receiving the message 636, a communication-session between the caller UE 102 and the target UE 106 is established.

The diverting UL 104 sends an acknowledgment 638 to the second proxy network entity 608. The acknowledgment 638 is directed to the AS 606 to notify about receiving the communication-diversion-notification 628. The second proxy network entity 608 forwards the acknowledgment 638 to the serving network entity 604, in form of a message 640. Finally, the serving network entity 604 forwards the acknowledgment 638 to the AS 606 in form of a message 642.

Therefore, it should be clear from the preceding disclosure that the present invention provides a method for managing communication-sessions in a network by sending communication-diversion-notifications corresponding to diverted communication-sessions. The user of the diverting UE can customize a communication-diversion-notification and can also control the rate at which they are received. Further, the communication-diversion-notification is provided in a standard format. The standard format helps in uniform implementation of the communication-diversion-notification across UEs from different vendors.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method of managing communication-sessions in a network, the method at a Communication Diversion Notification Server (CDNS) comprising:
receiving a message; and
sending a communication-diversion-notification to a diverting user equipment (UE) based. on filter-criteria, wherein the communication-diversion-notification is sent in response to the message, and wherein the communication-diversion-notification notifies the diverting UE about diversion of a communication-session to a target UE.

2. The method according to claim 1 further comprising diverting the communication-session to the target UE on receiving the message, wherein the communication-session is diverted based on a diversion-policy of the diverting UE.

3. The method as recited in claim 1, wherein the filter-criteria is defined by a user of the diverting UBE.

4. The method as recited in claim 1, wherein sending the communication-diversion-notification comprises delivering the communication-diversion-notification at a pre-defined rate.

5. The method as recited in claim 1, further comprising:
storing the communication-diversion-notification when the diverting UE is at least one of powered-off and out of coverage of the network; and
sending the communication-diversion-notification to the diverting UE when the diverting UE is powered-on and within coverage of the network.

6. A Communication Diversion Notification Server (CDNS) comprising:
a memory capable of storing filter-criteria;
a processor capable of generating a communication-diversion-notification based on the filter-criteria, wherein the communication-diversion-notification notifies a diverting user equipment (QE) about diversion of a communication-session to a target UE; and
a transceiver capable of sending the communication-diversion-notification to the diverting UE.

7. The CDNS as recited in claim 6, wherein the filter-criteria determine content of the communication-diversion-notification.

8. The CDNS as recited in claim 6, wherein the content of the communication-diversion-notification is selected from the group comprising information associated with a caller UE, information associated with the diverting UE, information associated with the target UE, time of the diversion of the communication-session, one or more reasons for the diversion of the communication-session and a rule for diverting the communication-session.

9. The CDNS as recited in claim 6, wherein the communication-diversion-notification is based on Extensible Mark up Language (XML)-based schema.

10. The CDNS as recited in claim 6, wherein the communication-diversion-notification is provided by a communication-diversion notification-service, wherein the communication-diversion notification-service uses a Session Initiation Protocol (SIP)-based Event Notification Framework.
